(19) United States
(12) Patent Application Publication
(10) Pub. No.: US 2005/0232647 A1
(43) Pub. Date: Oct. 20, 2005

(54) Electric device having charging function

(75) Inventor: Hiroyuki Takenaka, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/107,282

(22) Filed: Apr. 15, 2005

(30) Foreign Application Priority Data
Apr. 16, 2004 (JP) 2004-121666

(51) Int. Cl. G03G 15/08

(52) U.S. Cl. 399/27

(57) ABSTRACT

For charging in a non-contact manner, a mobile work robot is placed on a charging unit provided with a unit-side terminal providing an energy for charging. The mobile work robot receives an energy for charging the battery from the unit-side terminal via a robot-side terminal. For the charging, the mobile work robot is placed on the charging unit such that a surface provided with the robot-side terminal is opposed to a surface provided with the unit-side terminal. The surface portion provided with the robot-side terminal and the surface portion provided with the unit-side terminal form a protection unit, which is a space for cutting off a region for energy transmission for charging from an external side.

### BACKGROUND OF THE INVENTION

1. Field of the Invention

The present invention relates to an electric device having a charging function, and particularly to an electric device having a function of charging a battery of a target device.

2. Description of the Background Art

As a kind of electric devices of a rechargeable type, there has been a mobile work robot having functions of automatic moving and working. The mobile work robot has a rechargeable battery, which can be charged by a charging unit independent of the mobile work robot.

The charging unit is connected to a commercial power supply. When the mobile work robot is connected to the charging unit, a power is supplied from the commercial power supply to the mobile work robot to charge the battery. A cleaner employing the above charging method is disclosed, e.g., in Japanese Patent Laying-Open No. 2003-142164. The charging method disclosed in the above reference can charge a battery in a body of the cleaner by electrically or magnetically connecting a charging terminal of the cleaner body to a charging terminal of a charging base.

This reference has disclosed magnetic charging and thus the charging in a non-contact manner. Therefore, the charging base provides a magnetic flux energy, which is caused by an electromagnetic field produced during the charging operation, to the cleaner body, of which charging terminal is spaced by a predetermined distance from that of the charging base. When a foreign material enters a space between these charging terminals during the charging operation, or when another magnetic interference occurs therein, the magnetic field for the charging does not normally occurs so that the charging is impeded. If the foreign material in the space is metal, the metal causes a problem of heating. However, the above reference has neither disclosed nor suggested countermeasures against such problems.

For overcoming the above problems, such a manner has been proposed that a user arranges a special cover for protection over a portion, in which an electromagnetic field occurs for charging, during a charging operation. However, the user may forget about arranging the cover. The cover may be configured to cover automatically the space during the charging instead of a manual operation. This requires a mechanism for such automatic operation, and increases a cost.

### SUMMARY OF THE INVENTION

An object of the invention is to provide an electric device, which can easily preclude a factor impeding energy transmission in a non-contact manner during charging.

An electric device according to an aspect of the invention includes a charging unit having a unit surface provided with a unit-side terminal for outputting an energy for charging in a non-contact charging operation; a body having a body surface provided with a body-side terminal receiving the energy from the unit-side terminal for charging a battery; and a protection unit protecting a region transmitting the energy by cutting off the region from an external side. The protection unit is a space formed when the body is located on the charging unit with the body surface opposed to the unit surface in the non-contact charging operation, and defined between a surface portion provided with the body-side terminal in the body surface and a surface portion provided with the unit-side terminal in the unit surface.

Accordingly, only by locating the body on the charging unit with the body surface opposed to the unit surface in the non-contact charging operation, the protection unit, which is the space for cutting off the energy transmission region for charging the battery from the external side, is formed by the surface portion provided with the body-side terminal in the body surface and the surface portion provided with the unit-side terminal in the unit surface. Accordingly, a factor impeding the energy transmission in the con-contact charging operation can be easily precluded without arranging a special cover for protecting the energy transmission region.

Preferably, the surface portion provided with the unit-side terminal in the unit surface is a unit-side concavity concaved with respect to its surrounding surface portion. Since the surface portion provided with the unit-side terminal in the unit surface is concaved with respect to the surrounding surface portion, such a situation can be easily avoided that another member damages the unit-side terminal due to contact, even if the unit-side terminal is exposed.

Preferably, the charging unit further has a terminal raising unit for raising the unit-side terminal in the unit-side concavity toward the body surface when the body is located on the charging unit.

Since the unit-side terminal is raised toward the body-side terminal in the non-contact charging operation, such a situation can be avoided that the energy transmission cannot be performed sufficiently due to a large distance between the body-side terminal and the unit-side terminal located within the unit-side concavity.

Preferably, the terminal raising unit raises the unit-side terminal by utilizing a reaction or counteraction to a weight of the body applied to the charging unit when the body is located on the charging unit. Therefore, the raising of the unit-side terminal can be easily achieved by using the reaction to the application of the weight of the body.

Preferably, the surface portion provided with the body-side terminal in the body surface is a body-side concavity concaved with respect to its surrounding surface portion. Since the surface portion provided with the body-side terminal in the body surface is concaved with respect to the surrounding surface, such a situation can be easily avoided that another member damages the body-side terminal due to contact, even if the body-side terminal is exposed.

Preferably, a predetermined portion of the body and a predetermined portion of the charging unit are fitted with each other when the body is placed on the charging unit. Since these portions can be fitted only by locating the body on the charging unit, the body can be easily fixed to the charging unit in the non-contact charging operation.

Preferably, the body and the charging unit are provided with alignment marks for locating the body on the charging unit. By aligning the alignment marks, the body can be easily and reliably located on the charging unit to allow the non-contact charging.

Preferably, the body is a self-propelled robot. Therefore, the foregoing features related to the non-contact charging can be achieved in the self-propelled robot.

An electric device according to another aspect of the invention includes a charging unit having a unit surface provided with a unit-side terminal for outputting an energy for charging in a non-contact charging operation; a body having a body surface provided with a body-side terminal receiving the energy from the unit-side terminal for charging a battery; and a protection unit protecting a region transmitting the energy by cutting off the region from an external side. The protection unit is a space formed when the body is located on the charging unit with the body surface opposed to the unit surface in the non-contact charging operation, and defined between a surface portion provided with the body-side terminal in the body surface and a surface portion provided with the unit-side terminal in the unit surface. The surface portion provided with the unit-side terminal in the unit surface is a unit-side concavity concaved with respect to its surrounding surface portion. The charging unit further has a terminal raising unit for raising the unit-side terminal in the unit-side concavity toward the body surface when the body is located on the charging unit. The terminal raising unit raises the unit-side terminal by utilizing a reaction or counteraction to a weight of the body applied to the charging unit when the body is located on the charging unit. The surface portion provided with the body-side terminal in the body surface is a body-side concavity concaved with respect to its surrounding surface portion. A predetermined portion of the body and a predetermined portion of the charging unit are fitted with each other when the body is placed on the charging unit. The body and the charging unit are provided with alignment marks for locating the body on the charging unit. The body is a self-propelled robot.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B schematically show a mobile work robot.

FIGS. 2A and 2B show external appearances, and particularly show a bottom surface of the mobile work robot and a top surface of a charging unit, respectively.

FIG. 3 is a cross section taken along line III-III in FIG. 2B.

FIG. 4 is a cross section taken along line IV-IV in FIG. 2B.

FIG. 5 shows another example of a position of an electrode of a charging terminal during charging.

FIG. 6 shows the mobile work robot located on a charging unit.

FIG. 7 schematically shows a structure for moving the electrode of the charging terminal of the charging unit.

FIGS. 8A and 8B are cross sections taken along line VIII-VIII in FIG. 7.

FIG. 9 shows a state of the charging unit having a vertically movable charging terminal during not charging.

FIG. 10 shows a state of the structure having the vertically movable charging terminal electrode during charging.

FIGS. 11 and 12 show a structure having a nonconductive member arranged around the charging terminal of the charging unit.

### DESCRIPTION OF THE PREFERRED EMBODIMENTS

Embodiments of the invention will now be described with reference to the drawings. In each of the following embodiments, a mobile work robot, which is a kind of a self-propelled robot, is employed as an example of a target device to be charged. However, the target device is not restricted to it.

The following description will be primarily given on charging in a non-contact manner. Other functions of self-propelling of the robot and working as well as a mechanism of battery charging by an internal circuit are the same as those already known, and therefore will now be described in detail.

### First Embodiment

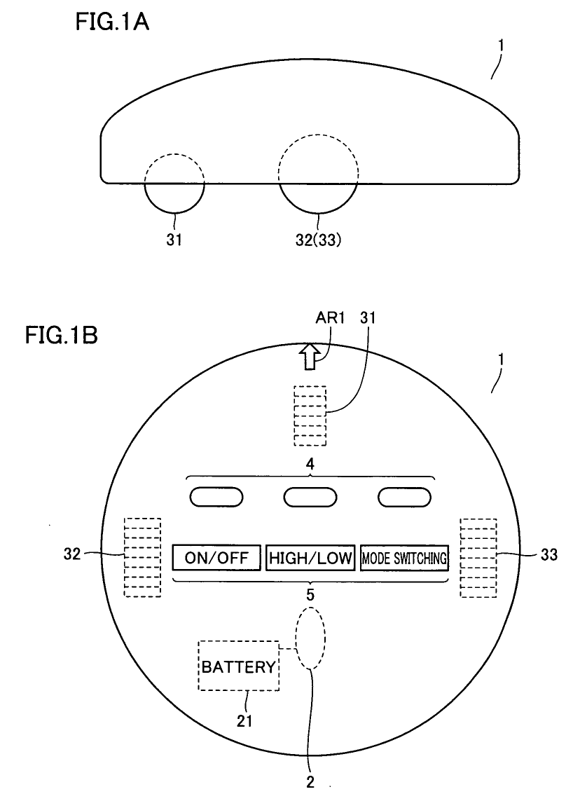

FIG. 1A shows an outer appearance of a side surface of a mobile work robot 1, and FIG. 1B shows an outer appearance of a top surface of mobile work robot 1. Referring to FIGS. 1A and 1B, mobile work robot 1 includes a front wheel 31 and rear wheels 32 and 33, which are in contact with a floor surface, and is driven to rotate for movement, as well as a LED (Light Emitting Diode) unit 4 arranged on the top surface of a casing of mobile work robot 1 for notifying of an operation mode by light, and a switch unit 5 for manual operation by a user. The casing of mobile work robot 1 is provided at its surface opposed to the floor surface with a charging terminal 2, which is exposed for non-contact charging. The casing of mobile work robot 1 is provided at its top surface with a mark AR1, which is used for positioning when mobile work robot 1 is to be placed on charging unit 1 as will be described later. The operation modes, which are notified by LED unit 4, include an operating mode, a charging mode representing a charging state and a charge-completed mode. Mobile work robot 1 is internally provided with a rechargeable battery 21, which supplies an electric power to various portions in mobile work robot 1. Battery 21 is charged with charging terminal 2.

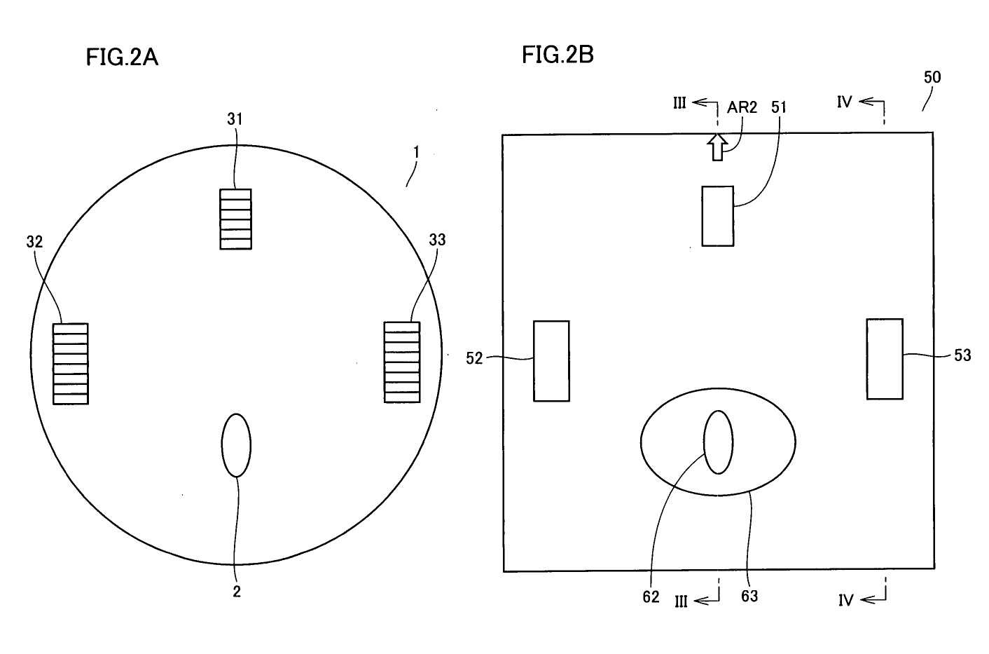

FIGS. 2A and 2B show an outer appearance of a bottom surface of mobile work robot 1 opposed to the floor surface and an outer appearance of a top surface of a charging unit 50. Referring to FIG. 2A, mobile work robot 1 is provided at its bottom surface, which is opposed to the floor surface when it moves on the floor, with wheels 31, 32 and 33 as well as charging terminal 2 in an exposed fashion. Referring to FIG. 2B, charging unit 50 has a top surface (i.e., a predetermined surface of a casing of charging unit 50), which is opposed to the bottom surface of mobile work robot 1 placed on charging unit 50, and is provided the top surface with wheel grooves 51-53, which are formed corresponding to wheels 31-33, respectively, a charging terminal 62 for non-contact charging and a concavity 63 formed around charging terminal 62. Concavity 63 is formed by partially concaving the top surface of charging unit 50. Charging terminal 62 is formed by exposing an electrode at the bottom concave surface of concavity 63.

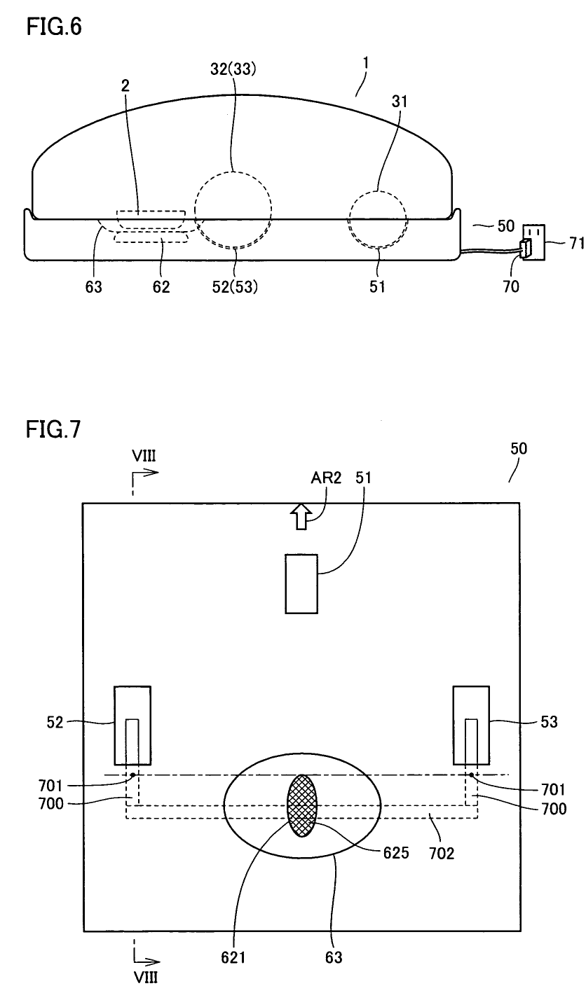

A mark AR2 is formed on the top surface of charging unit 50 for alignment or positioning. For charging, the user places mobile work robot 1 on charging unit 50 such that the mark AR1 on mobile work robot 1 matches with mark AR2 on charging unit 50. FIG. 6 schematically shows a state, in which mobile work robot 1 is joined to charging unit 50, as will be described later.

Although not shown, charging unit 50 is internally provided with a circuit unit, which causes high-frequency oscillation by converting a current provided from a commercial power supply to a DC current, and provides a magnetic flux energy produced on a primary side of a transformer (not shown) via charging terminal 62. The magnetic flux energy thus provided is received on a secondary side of the transformer (not shown) in mobile work robot 1, and is rectified for charging battery 21. Therefore, if a metal member or the like is placed on the top surface of charging unit 50, and receives the magnetic flux energy from charging terminal 62, it generates a heat. For preventing such heating, oscillation is caused intermittently when a metal member is placed thereon. When mobile work robot 1 is located thereon, the oscillation is performed continuously to provide the magnetic flux energy in a concentrated fashion, and the intermittent oscillation will be performed again when the end of charging is detected.

Although specific description is not given, mobile work robot 1 transmits a signal, which indicates the completion of the charging, to the primary side of the transformer of charging unit 50 via the secondary side of the transformer in mobile work robot 1 so that charging unit 50 can determine the completion of the charging.

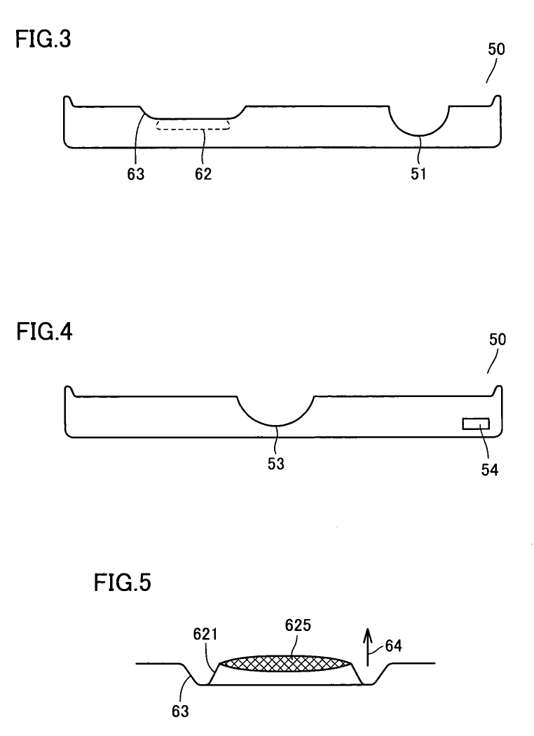

FIG. 3 shows a cross section taken along line III-III in FIG. 2B, and FIG. 4 shows a cross section taken along line IV-IV. FIG. 5 shows another example of a position of an electrode surface of charging terminal 62 during charging. FIG. 6 shows a state, in which mobile work robot 1 is placed on charging unit 50 for charging.

Referring to FIG. 3, since the electrode of charging terminal 62 is arranged at the bottom surface of concavity 63, the electrode surface provides a concaved surface in the top surface of charging unit 50. Therefore, even if an object other than mobile work robot 1 is carelessly placed on the top surface of charging unit 50, a space is formed between the object and the electrode of charging terminal 62, and thus prevents the contact between them so that damage to the electrode can be prevented.

For the charging operation, the user places mobile work robot 1 on charging unit 50 such that the button surface of mobile work robot 1 is opposed to the top surface of charging unit 50. In this placing operation, the user positions mobile work robot 1 to align mark AR1 on mobile work robot 1 to mark AR2 on charging unit 50. When mobile work robot 1 is placed, wheels 31-33 are partially fitted into wheel grooves 51-53, respectively. Thereby, wheels 31-33 are engaged with wheel grooves 51-53, respectively, so that mobile work robot 1 is fixed on charging unit 50 (see FIG. 6).

When mobile work robot 1 is fixed on charging unit 50 as shown in FIG. 6, the electrode of charging terminal 2 is opposed to the electrode of charging terminal 62 so that it reliably becomes possible to transmit a magnetic flux energy between the opposite terminals.

In the state shown in FIG. 6, the user operates a switch 54 (see FIG. 4) arranged on the side surface of charging unit 50 for starting the charging. By this operation, charging terminal 62 starts to provide the magnetic flux energy for charging to charging terminal 2. For sufficiently transmitting the provided magnetic flux energy to charging terminal 2, a predetermined gap or space between charging terminals 62 and 2 is covered with concavity 63 provided with charging terminal 62 and the partial surface provided with charging terminal 2. Consequently, the gap is protected in a closed space, which is cut off from an external side. This state can eliminate a possibility that an energy of another magnetic wave or a foreign material enters the above gap. Therefore, the transmission of the magnetic flux energy is not impeded so that battery 21 can be sufficiently charged.

In the above structure, the charging starts in response to the operation of switch 54. However, the structure may be configured to start the charging automatically. For example, sensors (not shown) may be arranged in wheel grooves 51-53 for detecting that wheels 31-33 are engaged with wheel grooves 51-53 as shown in FIG. 6, respectively, and the structure may be configured to start the charging in response to such detection by the sensors, and to end the charging in response to detection of the disengaging.

As shown in FIG. 6, charging unit 50 has a plug 70 connected to a receptacle 71 of the commercial power supply. Therefore, the commercial power supply supplies the power to charging unit 50 via receptacle 71 and plug 70.

### Second Embodiment

In FIG. 6, the electrode surface of charging terminal 62 is fixed substantially at the same vertical position or level as the bottom surface of concavity 63, and the electrode surface of charging terminal 2 of mobile work robot 1 projects from the bottom surface of mobile work robot 1 to an extent not impeding the movement. However, a reverse structure may be employed provided that the foregoing gap of the predetermined distance can be kept. The example will now be described with reference to FIGS. 5 and 7 to 10.

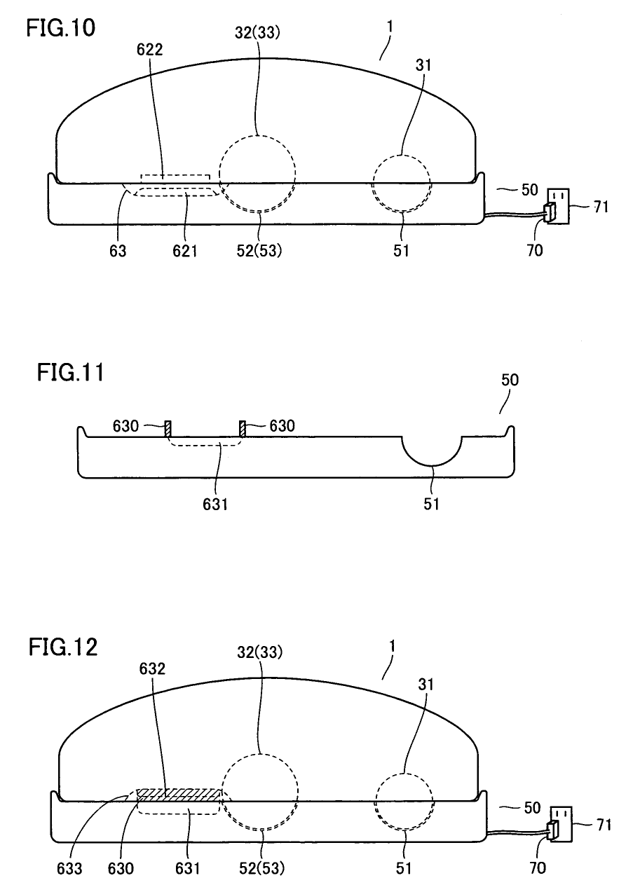

FIG. 5 shows a charging terminal 621, which is employed in place of charging terminal 62 in FIG. 3, and has an electrode surface 625. FIG. 10 shows a state, in which mobile work robot 1 is placed on charging unit 50. In FIG. 10, mobile work robot 1 has a charging terminal 622 in place of charging terminal 2. In a normal state, electrode surface 625 of charging terminal 621 of charging unit 50 is located at the same level are the bottom surface (concave surface) of concavity 63 as shown in FIG. 3. During the charging operation, however, electrode surface 625 of charging terminal 621 is raised as indicated by an arrow 64 and hatching in FIG. 5. Corresponding to it, the electrode surface of charging terminal 622 is substantially flush with the bottom surface of mobile work robot 1 (see FIG. 10). In this structure, when mobile work robot 1 is located on charging unit 50 to allow the charging, it is possible to keep the space or gap, which has the foregoing predetermined distance for transmitting the magnetic flux energy, and this space can be covered and protected by concavity 63 and others, similarly to the foregoing cases. In FIG. 10, the electrode surface of charging terminal 622 is substantially flush with the bottom surface of mobile work robot 1. However, the electrode surface of charging terminal 622 may be hollowed with respect to the bottom surface of mobile work robot 1.

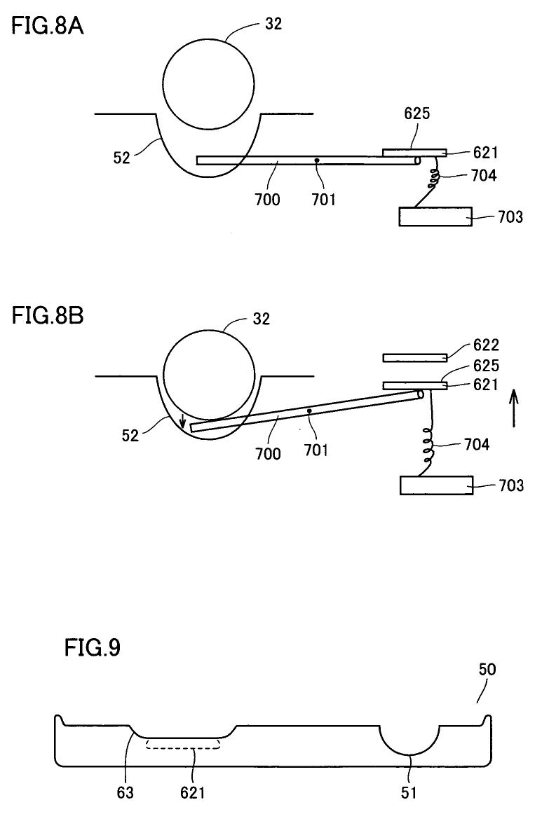

Referring to FIGS. 7, 8A and 8B, description will now be given on a mechanism, which raises charging terminal 621 by utilizing a reaction to a weight applied from mobile work robot 1 to charging unit 50 when mobile work robot 1 located on charging unit 50.

FIG. 7 shows portions forming the raising mechanism, and particularly shows levers 700 corresponding to respective wheel grooves 52 and 53, and a coupling bar 702 coupling opposite levers 700. One end of lever 700 is projected into the corresponding wheel groove, and the other end is connected to coupling bar 702. Each lever 700 is turnable around a fulcrum 701 located between the opposite ends. When one end of lever 700 lowers, lever 700 turns around fulcrum 701 to raise the other end. Charging terminal 621 is placed on a substantially central region of coupling bar 702. Charging terminal 621 is connected via an extensible lead wire 704 to a circuit board 703 for internal charging of charging unit 50. Lead wire 704 has a coil-like form for extension and contraction, but it may have another form. Lever 700 and coupling bar 702 are made of plastic material.

FIGS. 8A and 8B show cross sections taken along line VIII-VIII in FIG. 7. Referring to FIGS. 8A and 8B, when mobile work robot 1 placed on charging unit 50, wheel 32 moves into wheel groove 52, and comes into contact with one end of lever 700 in wheel groove 52 to lower the one end in the direction indicated by an arrow so that the other end of lever 700 rises in a direction indicated by an arrow. In parallel with this operation, wheel 33 moves into wheel groove 53, and comes into contact with one end of lever 700 in wheel groove 53 to lower the one end so that the other end of lever 700 rises, although this operation is not shown in the figure. Coupling bar 702 rises together with the rising of the other end of each lever 700 so that charging terminal 621 rises. Thereby, charging terminal 621, which had electrode surface 625 substantially flush with the bottom surface of concavity 63 as shown in FIG. 9, rises as shown in FIG. 10 so that electrode surface 625 moves toward charging terminal 622 of mobile work robot 1 to form a space, in which an energy is transmitted for charging, between opposite terminals 621 and 622.

When the charging is completed in the state shown in FIG. 10, LED unit 4 notifies of the completion of charging so that the user removes mobile work robot 1 in FIG. 10 from charging unit 50. When removed, wheels 32 and 33 of mobile work robot 1 are released from levers 700 in wheel grooves 52 and 53 so that one end of each lever 700 rises, and the other end lowers. Thus, levers 700 returns from the state in FIG. 8B to the state in FIG. 8A. Consequently, coupling bar 702 lowers, and electrode surface 625 and thus charging terminal 621 lower to the position in FIG. 9.

According to the second embodiment, it is possible to determine whether the charging can be performed or not, based on whether the one end of lever 700 is in contact with the wheel or not. Therefore, switching between start and end of the charging may be performed in response to detection/non-detection of such contact. More specifically, lever 700 may be internally provided at its one end with a sensor, which can detect the contact with the wheel so that the charging can be started in response to such detection, and can be ended when the contact is no longer detected.

### Third Embodiment

The foregoing structures use concavity 63 for forming the gap, which is used for the charging, and for protecting the electrode from damage. Instead of concavity 63, a nonconductive member 630 (e.g., a rubber wall) hatched in FIGS. 11 and 12 may be arranged to surround a charging terminal 631. Nonconductive member 630 has a ring-like form surrounding charging terminal 631, and is fixed to the top surface of charging unit 50. Since charging terminal 631 is always surrounded by nonconductive member 630, it is possible to prevent damage due to contact with another member. A height of the ring of nonconductive member 630 from the top surface of charging unit 50 is merely required to allow such a state that nonconductive member 630 substantially cuts off the space (gap), which is formed between charging terminal 632 of mobile work robot 1 and charging terminal 631 for magnetic flux transmission, from its external side in the charging operation. Since ring-like nonconductive member 630 can protect the gap, a concavity 633 having a depth corresponding to the height of the ring of nonconductive member 630 is formed on the bottom surface (i.e., the surface opposed to the floor surface) of mobile work robot 1, and charging terminal 632 is formed at the bottom surface of concavity 633. Thereby, charging terminal 632 is protected by concavity 633 during the movement of mobile work robot 1 so that it is possible to prevent damage to the electrode due to contact with the floor or the like.

Although the present invention has been described and illustrated in detail, it is clearly understood that the same is by way of illustration and example only and is not to be taken by way of limitation, the spirit and scope of the present invention being limited only by the terms of the appended claims.

1. An electric device comprising:
a charging unit having a unit surface provided with a unit-side terminal for outputting an energy for charging in a non-contact charging operation;
a body having a body surface provided with a body-side terminal receiving said energy from said unit-side terminal for charging a battery; and
a protection unit protecting a region transmitting said energy by cutting off said region from an external side, wherein
said protection unit includes a space formed when said body is located on said charging unit with said body surface opposed to said unit surface in said non-contact charging operation, and defined between a surface portion provided with said body-side terminal in said body surface and a surface portion provided with said unit-side terminal in said unit surface.

2. The electric device according to claim 1, wherein
the surface portion provided with said unit-side terminal in said unit surface is a unit-side concavity concaved with respect to its surrounding surface portion.

3. The electric device according to claim 2, wherein
said charging unit further has a terminal raising unit for raising said unit-side terminal in said unit-side concavity toward said body surface when said body is located on said charging unit.

4. The electric device according to claim 3, wherein
said terminal raising unit raises said unit-side terminal by utilizing a reaction to a weight of said body applied to said charging unit when said body is located on said charging unit.

5. The electric device according to claim 4, wherein
said charging unit further has:
a groove formed at said unit surface such that a portion of said body falls into said groove when said body is located on said charging unit, and
a lever having one end projected into said groove, provided at the other end side with said unit-side terminal, and being turnable around a fulcrum between said one and the other ends; and
when said portion of said body falls into said groove to come into contact with the one end of said lever, said lever turns around said fulcrum to raise said other end.

6. The electric device according to claim 5, wherein
said body further has a wheel for movement, and
said portion of said body is said wheel.

7. The electric device according to claim 6, wherein
said wheel is fitted into said groove when said body is located on said charging unit.

8. The electric device according to claim 4, wherein
a surface of the portion provided with said unit-side terminal in said unit surface is a unit-side concavity concaved with respect to its surrounding surface portion.

9. The electric device according to claim 8, wherein
a predetermined portion of said body and a predetermined portion of said charging unit are fitted with each other when said body is placed on said charging unit.

10. The electric device according to claim 9, wherein
said body and said charging unit are provided with alignment marks for locating said body on said charging unit.

11. The electric device according to claim 10, wherein
said body is a self-propelled robot.

12. The electric device according to claim 1, wherein
the surface portion provided with said unit-side terminal in said unit surface is substantially flush with its surrounding surface portion, and
the surface portion provided with said body-side terminal in said body surface is a body-side concavity concaved with respect to its surrounding surface portion.

13. The electric device according to claim 12, wherein
said charging unit has a wall formed at the surface portion provided with said unit-side terminal, and surrounding said unit-side terminal for protecting said unit-side terminal, and
said wall forms a part of said protection unit.

14. An electric device comprising:
a charging unit having a unit surface provided with a unit-side terminal for outputting an energy for charging in a non-contact charging operation;
a body having a body surface provided with a body-side terminal receiving said energy from said unit-side terminal for charging a battery; and
protection means for protecting a region transmitting said energy by cutting off said region from an external side, wherein
said protection means includes a space formed when said body is located on said charging unit with said body surface opposed to said unit surface in said non-contact charging operation, and defined between a surface portion provided with said body-side terminal in said body surface and a surface portion provided with said unit-side terminal in said unit surface.

15. An electric device comprising:
a groove formed at a predetermined surface of a casing; and
a lever having one end projected into said groove and the other end carrying a terminal for charging a target, and being turnable around a fulcrum located between said one and other ends, wherein
when a part of said target falls into said groove, and comes into contact with the one end of said lever, said lever turns around said fulcrum in response to said contact to lower said one end and to raise said other end.
